(19) United States
(12) Patent Application Publication
(10) Pub. No.: US 2018/0096523 A1
(43) Pub. Date: Apr. 5, 2018

(54) DISPLAY CONTROL METHODS AND APPARATUSES

(71) Applicant: Beijing Zhigu Rui Tuo Tech Co., Ltd, Beijing (CN)

(72) Inventor: Liang ZHOU, Beijing (CN)

(21) Appl. No.: 15/565,353

(22) PCT Filed: Apr. 7, 2016
(86) PCT No.: PCT/CN2016/078686

§ 371 Date: Oct. 9, 2017

(30) Foreign Application Priority Data
Apr. 10, 2015 (CN) 2015101707512

(51) Int. Cl. G06T 15/50

(52) U.S. Cl. CPC G06T 15/506; G06T 2219/2012

(57) ABSTRACT

Various display control methods and apparatuses are described. One of the methods comprises: adjusting a light distribution of a presentation area according to at least a light effect of a virtual content and information about a first presentation position of the virtual content in the presentation area; and controlling a display device to display the virtual content according to the information about the first presentation position. In this regard, visual authenticity of the virtual content during migration and display is achieved, and the display effect of the virtual content is improved.

### RELATED APPLICATION

The present international patent cooperative treaty (PCT) application claims the benefit of priority to Chinese Patent Application No. 201510170751.2, filed on Apr. 10, 2015, and entitled “Display Control Methods and Apparatuses”, which application is hereby incorporated into the present international PCT application by reference herein in its entirety.

### TECHNICAL FIELD

The present application relates to the field of display technologies, and, for example, to various display control methods and apparatuses.

### BACKGROUND

Augmented reality (AR) technology is to acquire a virtual content by means of one or more technologies such as computer image capturing, image processing and visualization, “place” the virtual content in a real environment, and present, by means of a display device, to a user a “new environment” that integrates the virtual content and a real environment.

The augmented reality technology is widely used in the fields of games, film and television, entertainment, art, education, medical treatment, etc. In recent years, the augmented reality technology has been developing to improve augmented reality display characteristics, for example, light projection information of a virtual content may be added according to an illumination condition of a real environment. In this way, visually the virtual content looks more like an object that exists in the real environment, enabling a user to have a better sensory perception of reality of virtual-real integration.

### SUMMARY

A brief summary about the present application is given hereinafter, so as to provide a basic understanding about certain aspects of the present application. It should be understood that the summary is not an exhaustive summary about the present application. It is neither intended to determine critical or important parts of the present application, nor intended to limit the scope of the present application. Its purpose is merely giving some concepts in a simplified form, to be taken as the preamble to be described later in more detail.

The present application provides various display control methods and apparatuses.

According to one aspect, an embodiment of the present application provides a display control method, comprising:

adjusting a light distribution of a presentation area according to at least a light effect of a virtual content and information about a first presentation position of the virtual content in the presentation area; and

controlling a display device to display the virtual content according to the information about the first presentation position.

According to another aspect, an embodiment of the present application provides a display control apparatus, comprising:

a light distribution adjusting module, configured to adjust a light distribution of a presentation area according to at least a light effect of a virtual content and information about a first presentation position of the virtual content in the presentation area; and

a virtual content display control module, configured to control a display device to display the virtual content according to the information about the first presentation position.

By means of the embodiments of the present application, the light distribution of the presentation area can be adjusted according to at least the light effect of the virtual content and the information about the first presentation position of the virtual content in the presentation area, to cause that the adjusted light distribution of the presentation area is more adaptive to the light effect of the virtual content. In other words, in a case where the light effect of the virtual content is not changed, the light distribution of the presentation area is changed, to cause that the light effect of the virtual content presented in the presentation area looks more like a real light effect generated as if the virtual content really exists in the presentation area, which helps achieve visual authenticity of the virtual content during migration and display, and improve the display effect of the virtual content.

These and other aspects of the present application will be more evident through the following detailed description about optional embodiments of the present application with reference to the accompanying drawings.

### BRIEF DESCRIPTION OF THE DRAWINGS

The present application can be better understood with reference to the description given below in combination with the accompanying drawings, in which the same or similar reference signs are used in all the drawings to indicate the same or similar components. The drawings together with the following detailed description are comprised in the specification and form a part of the specification, and are configured to further exemplify alternative embodiments of the present application and explain the principle and advantages of the present application. In the drawings:

FIG. 1 is a flowchart of a display control method according to an example embodiment of the present application;

FIG. 2a is an optional example of adjusting a light distribution of a presentation area according to an example embodiment of the present application;

FIG. 2b is an example of a source light distribution in a capture scenario corresponding to a virtual content according to an example embodiment of the present application;

FIG. 2c is another optional example of adjusting a light distribution of the presentation area according to an example embodiment of the present application;

FIG. 2d is still another optional example of adjusting a light distribution of the presentation area according to an embodiment of the present application;

FIG. 3 is a logical block diagram of a display control apparatus according to an example embodiment of the present application;

FIG. 4 is a logical block diagram of another display control apparatus according to an example embodiment of the present application; and

FIG. 5 is a logical block diagram of still another display control apparatus according to an example embodiment of the present application.

A person skilled in the art should understand that, elements in the accompanying drawings are merely shown for simplicity and clearness, and may not be drawn proportionally. For example, the sizes of some elements in the accompanying drawings may be enlarged relative to other elements, so as to help improve understanding of the embodiments of the present application.

### DETAILED DESCRIPTION

Exemple embodiments of the present application are described below in detail with reference to the accompanying drawings. For the sake of clarity and simplicity, not all the features of actual implementations are described in the specification. However, it should be understood that, lots of decisions specific to implementations must be made during development of any such actual embodiment, so as to achieve specific goals of developers, for example, restrictions relevant to systems and services are met, and the restrictions may vary with different implementations. In addition, it should also be understood that, although development work is likely to be very complicated and time-consuming, for those skilled in the art who benefit from the disclosure, the development work is merely a routine task.

Herein, it should also be noted that, in order to avoid blurring the present application due to unnecessary details, apparatus structures and/or processing steps closely related to solutions according to the present application are described in the accompanying drawings and the specification, but representation and description about members and processing having little to do with the present application and known to those of ordinary skill in the art are omitted.

Exemple embodiments of the present application are further described below in detail with reference to the accompanying drawings (in which like elements are denoted by like reference numerals) and embodiments. The following embodiments are used for describing the present application, but are not intended to limit the scope of the present application.

A person skilled in the art may understand that the terms such as “first” and “second” in the present application are used only to differentiate different steps, devices, modules, or the like, and neither represent any specific technical meaning, nor indicate any logical relationship between the terms.

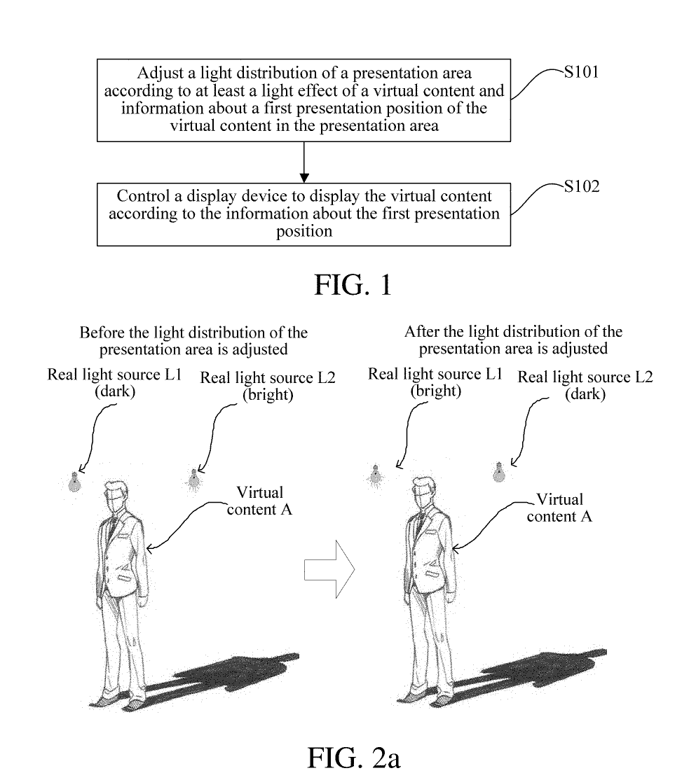

FIG. 1 is a flowchart of a display control method according to an embodiment of the present application. The display control method provided by this embodiment of the present application may be executed by a display control apparatus. The display control apparatus can perform display control by executing the display control method in, but not limited to, a virtual content display and application process, for example, image/video display and playback. The implementation of the display control apparatus is not limited. For example, the display control apparatus may be an independent component that cooperates and communicates with a display device; or the display control apparatus may be a functional module integrated into a display device, which is not limited in this embodiment of the present application.

Specifically, as shown in FIG. 1, the display control method provided by this embodiment of the present application comprises:

S101: Adjust a light distribution of a presentation area according to at least a light effect of a virtual content and information about a first presentation position of the virtual content in the presentation area.

S102: Control a display device to display the virtual content according to the information about the first presentation position.

The virtual content does not really exist in the presentation area, and the virtual content may be generated by synthesis with a computer; or the virtual content may be a content really captured in another real environment. For example, information of a dancer acquired according to a really-taken video of the dancer acting on a stage A may be used as a virtual content (for example, a display space B at home, etc.) that is to be migrated to and displayed in a presentation area, and so on. The presentation area may be an area of a real environment, an area of a virtual environment or an area where a real environment and virtual information are integrated, or the like, which can be specifically determined according to practical application requirements.

In the present application, the virtual content itself has a certain light effect, which is an illumination effect that is generated on the virtual content by a real or a real and virtual integrated light field. In practical application, the light effect may comprise, but is not limited to, distribution of light luminance and/or distribution of light color temperature that is generated by a distributed light field acting on the virtual content. For example, a part of the virtual content facing toward light is different from a part of the virtual content facing away from light in terms of light luminance distribution; the former has a higher luminance, and the latter has a lower luminance (or even appears to be a shadow), thereby forming, on the virtual content, an illumination effect of bright and dark distribution. For another example, a part of the virtual content close to a red light source is different from a part of the virtual content close to a yellow light source in terms of light color temperature distribution, thereby forming, on the virtual content, illumination effects of different light color temperature distributions. The distribution of light luminance and the distribution of light color temperature may be realized on the virtual content at the same time. In all these scenarios, the technical solution provided in this embodiment of the present application can be used to perform display control, thereby improving applicability of the solution of this embodiment of the present application.

With respect to this embodiment of the present application, the light effect of a virtual content can be enhanced or changed according to the light distribution of a presentation area. For example, a shadow of the virtual content may be enhanced or changed according to the light distribution of the presentation area. However, in some cases such as that it is difficult to process the light effect of the virtual content in later stages or that the light effect of the virtual content needs to be migrated to and displayed in the presentation area, the conventional method cannot satisfy the foregoing application requirements.

A difference may exist between the light effect of the virtual content itself and a real light effect generated when the virtual content really exists in the same position of the presentation area, and the difference between both may affect the perception of reality of a user visually. To this end, by means of this embodiment of the present application, the light distribution of the presentation area can be adjusted according to at least the light effect of the virtual content and the information about the first presentation position of the virtual content in the presentation area, to cause that the adjusted light distribution of the presentation area is more adaptive to the light effect of the virtual content. In other words, in a case where the light effect of the virtual content is not changed, the light distribution of the presentation area is changed, to cause that the light effect of the virtual content presented in the presentation area looks more like a real light effect generated as if the virtual content really exists in the presentation area, which helps achieve visual authenticity of the virtual content during migration and display, and improve the display effect of the virtual content.

It should be noted that the foregoing S101 and S102 are not strictly limited to a particular time order, and the time order of the two can be determined according to practical application requirements. For example, S101 may be executed first to adjust the light distribution of the presentation area, followed by executing S102 to display the virtual content in the presentation area. For another example, S102 may be executed first to display the virtual content in the presentation area, followed by executing S101 to adjust the light distribution of the presentation area.

Optionally, the information about the first presentation position of the virtual content in the presentation area may be acquired in advance. Or, the display control method may also comprise a step of determining the information about the first presentation position. For example, a 3D model of the presentation area may be acquired, and it is aligned the virtual content and a certain reference object in the 3D model of the presentation area in terms of shape, position and/or size or other parameters. In this way, it is determined the information about the first presentation position of the virtual content in the presentation area. By means of the step of determining the information about the first presentation position, a presentation position of the virtual content in the presentation area can be determined according to practical requirements, and the presentation position can be flexibly changed according to practical requirements, thereby better satisfying diversified practical application requirements.

According to this embodiment of the present application, a display device can be controlled to display the virtual content according to the information about the first presentation position. The display device displaying the virtual content may comprise, but is not limited to, a projection display device, a holographic display device, a near-to-eye display device, and the like. For example, the near-to-eye display device is used to display, in the presentation area, the virtual content, so as to provide a user with an immersive experience, and improve the display effect of the virtual content.

The light distribution of the presentation area may be adjusted according to at least the light effect of the virtual content and the information about the first presentation position, and the implementation manner may be flexibly determined according to a practical application requirement, to which the embodiments of the present application do not limit.

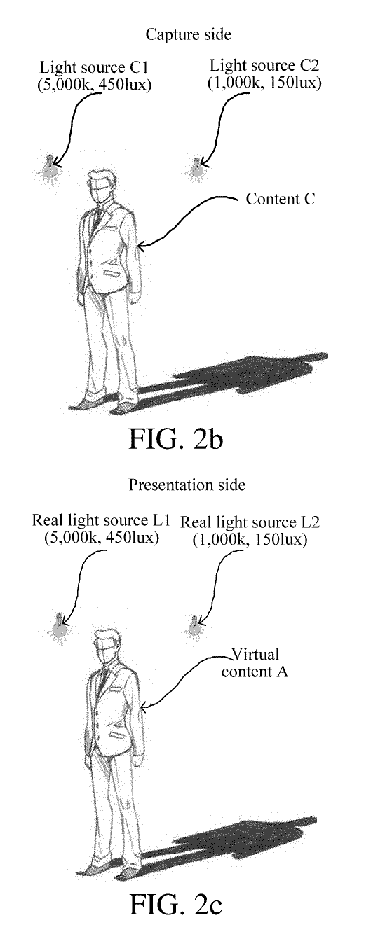

In some cases, the presentation area (for example, a real area or a virtual-real fused area) comprises at least one real light source. Optionally, the adjusting a light distribution of a presentation area comprises: adjusting an illumination characteristic of at least one real light source in the presentation area according to at least the light effect and the information about the first presentation position, so as to adjust the light distribution of the presentation area. In practical application, the presentation area may have one or more real light sources. In this solution, in order to match the light effect of the virtual content itself displayed in the first presentation position, the illumination characteristic of at least one real light source of the presentation area can be adjusted. In this way, an excessive difference or even a discrepancy between the light effect of the virtual content itself displayed in the first presentation position and the real light effect that may be generated by the at least one real light source on the really existent content of the first presentation position can be avoided. For example, as shown in FIG. 2a, there is excessive difference or even a discrepancy (for example, a left L1 is darker but a right L2 is brighter) between the illumination effect generated by the luminance distribution (for example, the left is brighter but the right is darker) of the virtual content itself and the illumination effect generated, in the same presentation position, by the light distribution formed by the real light sources L1 and L2 in the presentation area. Therefore, the real light sources in the presentation area are adjusted. For example, the luminance of light emission of the real light sources L1 and L2 is adjusted, to cause that a luminance distribution trend (for example, the left is brighter but the right is darker) generated, by the adjusted real light sources L1 and L2, on the really existent content of the same presentation position in the presentation area is as close as possible to or even the same as that (for example, the left is brighter but the right is darker) of the virtual content itself. In this solution, the illumination characteristic of the real light source in the presentation area may be adjusted, to cause that the real illumination effect generated, by the presentation area where the light distribution is adjusted, on the presentation position corresponding to the virtual content may be as close as possible to the light effect of the virtual content itself, thereby improving the sense of reality of the virtual content during migration and display, and improving the display effect of the virtual content.

Optionally, the illumination characteristic of the real light source comprises at least one of the following: a light-emitting direction, a luminance of light emission and a color temperature of light emission. The foregoing one or more illumination characteristics of the real light source may have greater impact on the real illumination effect that may be generated on the presentation position corresponding to the virtual content. By adjusting illumination characteristics of the real light source, for example, the light-emitting direction, the luminance of light emission and/or the color temperature of light emission or the like, the complexity of adjusting the light distribution of the presentation area can be reduced, and the efficiency of adjusting the light distribution can be improved.

Optionally, the adjusting an illumination characteristic of at least one real light source in the presentation area comprises: acquiring information about a source light distribution that generates the light effect on the virtual content; and adjusting the illumination characteristic of the at least one real light source in the presentation area according to at least the information about the source light distribution and the information about the first presentation position. The information about the source light distribution may comprise but is not limited to light information about distribution of a capture scene when the virtual content is captured. The information about the source light distribution may comprise but is not limited to the illumination characteristic of the light source. The illumination characteristic may comprise but is not limited to the light-emitting direction, the luminance of light emission and/or the color temperature of light emission or the like. Supposing that a content C really exists in the capture scene corresponding to the virtual content A, the light information about distribution of the capture scene of the content C comprises a light source C1 and a light source C2. The relation between the relative positions of the light source C1 and the light source C2 and the information about the source light distribution, for example, luminance and color temperature or the like of various light sources are as shown in FIG. 2b, and the foregoing source light distribution acts on the content C, thus forming the light effect. In order to provide migration and display, in the presentation area, the information about the source light distribution, in the capture scene, acquired by a capture object (e.g., a virtual content A having a certain light effect) of the content C. As shown in FIG. 2c, it is adjusted, according to the information about the source light distribution, the relation between the relative positions of the light source C1 and the light source C2 in the presentation area and the first presentation position of the virtual content A and one or multiple pieces of information, for example, luminance and color temperature or the like of various light sources, thereby adjusting the light-emitting direction, the luminance of light emission and/or the color temperature of light emission of the real light sources L1 and L2, and then adjusting the light distribution of the presentation area, to cause that the adjusted light distribution of the presentation area is as close as possible to or even the same as the information about the source light distribution of a capture side corresponding to the virtual content A, so as to improve the display effect of content migration. In this solution, at least one real light source of the presentation area is adjusted according to the information about the source light distribution that generates the light effect of the virtual content. This solution is simple and easy to implement.

With reference to any technical solution provided in the embodiments of the present application, optionally, the adjusting a light distribution of a presentation area comprises: determining, according to at least the light effect and the information about the first presentation position, virtual light augmentation information and information about a second presentation position of the virtual light augmentation information in the presentation area; and controlling the display device to display the virtual light augmentation information according to the information about the second presentation position. In some cases, the display effect of the virtual content can be improved by means of the virtual light augmentation information if the adjustment of some of real light sources in the presentation area is inconvenient and/or restricted or the presentation area is a virtual area, etc. The virtual light augmentation information may comprise but is not limited to information about distribution of the virtual light luminance and/or light color temperature. It is adjusted the light distribution of the presentation area visually, to cause that the adjusted light distribution of the presentation area is as close as possible to or even the same as the light distribution required for generating the light effect of the virtual content, thereby improving the display effect of the virtual content. The information about the second presentation position of the virtual light augmentation information in the presentation area may comprise but is not limited to: inadequate adjustment of the light distribution of the presentation area by means of the real light source, and/or failure in adjusting the light distribution by means of the real light source, and/or a certain space area needing adjusting the light distribution of a virtual area. As shown in FIG. 2d, the virtual light augmentation information is displayed in the space area. The display mode of the virtual light augmentation information is quite flexible. For example, the virtual light augmentation information may be displayed in the space area by changing a gray value and/or a luminance value of a virtual image, etc. This is equivalent to generating, by a virtual light source X (the virtual light source X may be visible or invisible in a user's field of view, to which the embodiments of the present application do not limit) in the space area, a visual effect similar to the light effect, thereby improving the display effect of the virtual content in the presentation area.

Further optionally, the determining, according to at least the light effect and the information about the first presentation position, virtual light augmentation information and information about a second presentation position of the virtual light augmentation information in the presentation area comprises: determining, according to the light effect, the information about the first presentation position and the light distribution of the presentation area, the virtual light augmentation information and the information about the second presentation position of the virtual light augmentation information in the presentation area. In this solution, the virtual light augmentation information and the presentation position thereof in the presentation area are determined by reference to the light distribution in the presentation area. Therefore, this solution may be used as a supplement to other means for adjusting the light distribution of the presentation area. In other words, the display effect of the virtual content can be improved by supplementing the virtual light augmentation information if the adjustment of some of real light sources in the presentation area is inconvenient and/or restricted, etc.

The embodiments of the present application may be applicable to a static display of the virtual content, or be applicable to a dynamic display of the virtual content. If the first presentation position of the virtual content in the presentation area is changed, optionally, the display control method further comprises: adjusting the light distribution of the presentation area according to at least the light effect and the changed information about the first presentation position of the virtual content in response to a change in the first presentation position of the virtual content in the presentation area. A change in the first presentation position comprises one or more changes of relative rotation, relative motion or posture change or the like of the virtual content relative to the previous state. By means of this solution, the light distribution of the presentation area can be adjusted accordingly as the position of the virtual content changes, to cause that the current light distribution of the presentation area may better match with the light effect of the virtual content when the virtual content is in the current position of the presentation area, so as to improve the display effect of the virtual content during migration and display.

Optionally, the display control method further comprises: in response to a change in the first presentation position of the virtual content in the presentation area, updating the virtual light augmentation information and the information about the second presentation position of the virtual light augmentation information in the presentation area; and controlling the display device to display the updated virtual light augmentation information according to the updated information about the second presentation position. By means of this solution, the virtual light augmentation information of the presentation area and the presentation position thereof can be adjusted according to the presentation position of the virtual content and the light distribution of the presentation area, to cause that the overall light distribution presented in the user's field of view may better match with light effect of the virtual content when the virtual content is in the current position of the presentation area, so as to improve the display effect of the virtual content during migration and display.

A person skilled in the art may understand that in any one of the foregoing methods of the example embodiments of the present application, the value of the serial number of each step does not mean an execution sequence, and the execution sequence of each step should be determined according to the function and internal logic thereof, and should not be any limitation on the implementation procedure of the specific example embodiments of the present application.

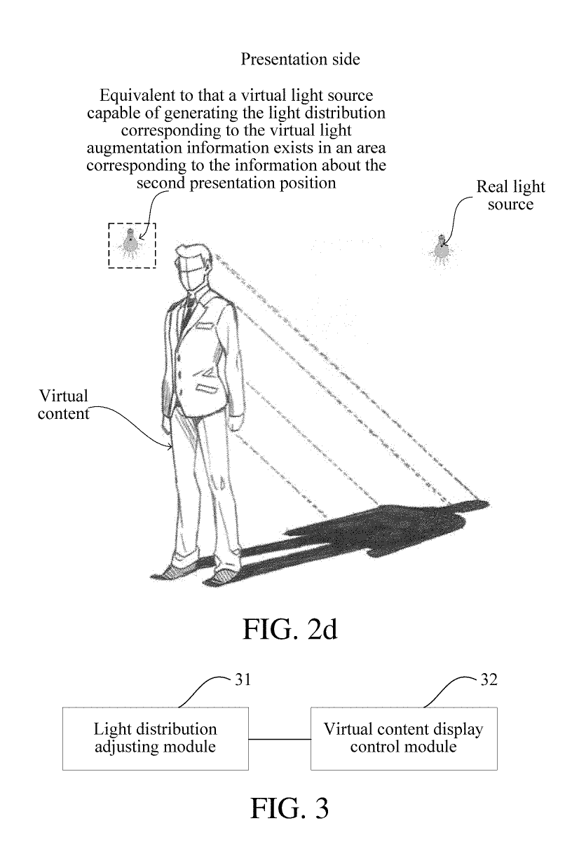

FIG. 3 is a logical block diagram of a display control apparatus according to an embodiment of the present application. As shown in FIG. 3, the display control apparatus provided by this embodiment of the present application comprises: a light distribution adjusting module 31 and a virtual content display control module 32.

The light distribution adjusting module 31 is configured to adjust a light distribution of a presentation area according to at least a light effect of a virtual content and information about a first presentation position of the virtual content in the presentation area.

The virtual content display control module 32 is configured to control a display device to display the virtual content according to the information about the first presentation position.

By means of this embodiment of the present application, the light distribution of the presentation area can be adjusted according to at least the light effect of the virtual content and the information about the first presentation position of the virtual content in the presentation area, to cause that the adjusted light distribution of the presentation area is more adaptive to the light effect of the virtual content. In other words, in a case where the light effect of the virtual content is not changed, the light distribution of the presentation area is changed, to cause that the light effect of the virtual content presented in the presentation area looks more like a real light effect generated as if the virtual content really exists in the presentation area, which helps achieve visual authenticity of the virtual content during migration and display, and improve the display effect of the virtual content.

The implementation of the display control apparatus is not limited. For example, the display control apparatus may be an independent component that cooperates and communicates with a display device; or the display control apparatus may be a functional module integrated into a display device, which is not limited in this embodiment of the present application. Optionally, the display device may comprise, but is not limited to, a projection display device, a holographic display device, a near-to-eye display device, and the like. For example, the near-to-eye display device is used to display, in the presentation area, the virtual content, so as to provide a user with an immersive experience, and improve the display effect of the virtual content.

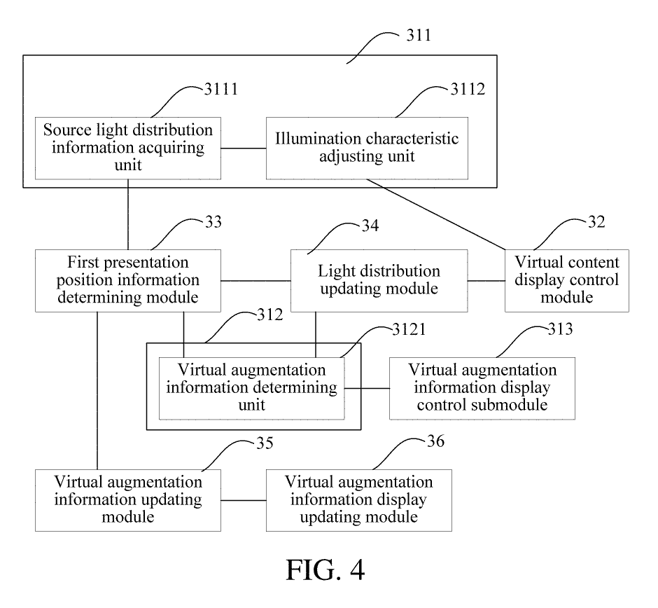

Optionally, as shown in FIG. 4, the light distribution adjusting module 31 comprises: a real light source adjusting submodule 311. The real light source adjusting submodule 311 is configured to adjust an illumination characteristic of at least one real light source in the presentation area according to at least the light effect and the information about the first presentation position, so as to adjust the light distribution of the presentation area. In this solution, the illumination characteristic of the real light source in the presentation area may be adjusted, to cause that the real illumination effect generated, by the presentation area where the light distribution is adjusted, on the presentation position corresponding to the virtual content may be as close as possible to the light effect of the virtual content itself, thereby improving the sense of reality of the virtual content during migration and display, and improving the display effect of the virtual content.

Optionally, the real light source adjusting submodule 311 comprises: a source light distribution information acquiring unit 3111 and an illumination characteristic adjusting unit 3112. The source light distribution information acquiring unit 3111 is configured to acquire information about a source light distribution that generates the light effect on the virtual content; and the illumination characteristic adjusting unit 3112 is configured to adjust an illumination characteristic of at least one real light source in the presentation area according to at least the information about the source light distribution and the information about the first presentation position. In this solution, at least one real light source of the presentation area is adjusted according to the information about the source light distribution that generates the light effect of the virtual content. This solution is simple and easy to implement.

Optionally, the illumination characteristic of the real light source comprises at least one of the following: a light-emitting direction, a luminance of light emission and a color temperature of light emission. The foregoing one or more illumination characteristics of the real light source may have greater impact on the real illumination effect that may be generated on the presentation position corresponding to the virtual content. By adjusting illumination characteristics of the real light source, for example, the light-emitting direction, the luminance of light emission and/or the color temperature of light emission or the like, the complexity of adjusting the light distribution of the presentation area can be reduced, and the efficiency of adjusting the light distribution can be improved.

Optionally, the display control device may further comprise: a first presentation position information determining module 33. The first presentation position information determining module 33 is configured to determine the information about the first presentation position of the virtual content in the presentation area. By means of the step of determining the information about the first presentation position, a presentation position of the virtual content in the presentation area can be determined according to practical requirements, and the presentation position can be flexibly changed according to practical requirements, thereby better satisfying diversified practical application requirements.

Optionally, the light distribution adjusting module 31 comprises: a virtual augmentation information determining submodule 312 and a virtual augmentation information display control submodule 313. The virtual augmentation information determining submodule 312 is configured to determine, according to at least the light effect and the information about the first presentation position, virtual light augmentation information and information about a second presentation position of the virtual light augmentation information in the presentation area; and the virtual augmentation information display control submodule 313 is configured to control the display device to display the virtual light augmentation information according to the information about the second presentation position. By means of this solution, the display effect of the virtual content may be improved by means of the virtual light augmentation information. Further optionally, the virtual augmentation information determining submodule 312 comprises: a virtual augmentation information determining unit 3121, configured to determine the virtual light augmentation information and the information about the second presentation position of the virtual light augmentation information in the presentation area according to the light effect, the information about the first presentation position and the light distribution of the presentation area. By means of this solution, the display effect of the virtual content may be improved by supplementing the virtual light augmentation information. Optionally, the virtual light augmentation information comprises: information about distribution of a virtual light luminance and/or light color temperature. Optionally, the light effect of the virtual content comprises: distribution of the light luminance and/or light color temperature in the virtual content.

Optionally, the display control device may further comprise: a light distribution updating module 34. The light distribution updating module 34 is configured to: in response to a change in the first presentation position of the virtual content in the presentation area, adjust the light distribution of the presentation area according to at least the light effect and the changed information about the first presentation position of the virtual content. By means of this solution, the light distribution of the presentation area can be adjusted accordingly as the position of the virtual content changes, to cause that the current light distribution of the presentation area may better match with the light effect of the virtual content when the virtual content is in the current position of the presentation area, so as to improve the display effect of the virtual content during migration and display.

Optionally, the display control device may further comprise: a virtual augmentation information updating module 35 and a virtual augmentation information display updating module 36. The virtual augmentation information updating module 35 is configured to: in response to a change in the first presentation position of the virtual content in the presentation area, update the virtual light augmentation information and the information about the second presentation position of the virtual light augmentation information in the presentation area; and the virtual augmentation information display updating module 36 is configured to control the display device to display the updated virtual light augmentation information according to the updated information about the second presentation position. By means of this solution, the virtual light augmentation information of the presentation area and the presentation position thereof can be adjusted according to the presentation position of the virtual content and the light distribution of the presentation area, to cause that the overall light distribution presented in the user's field of view may better match with light effect of the virtual content when the virtual content is in the current position of the presentation area, so as to improve the display effect of the virtual content during migration and display.

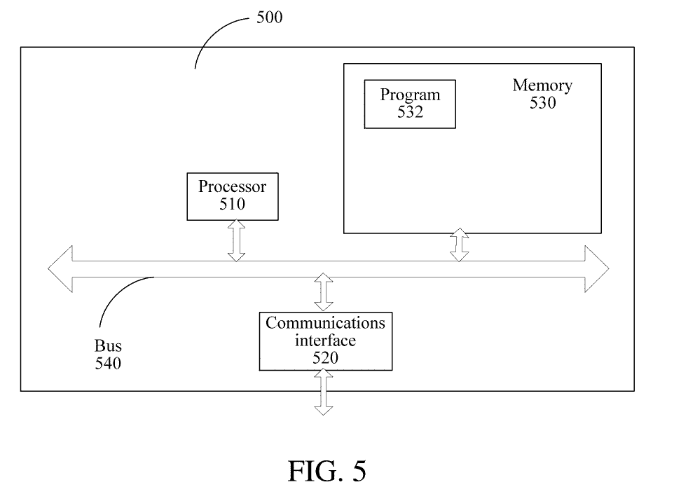

FIG. 5 is a structural block diagram of another display control apparatus according to an embodiment of the present application. However, this specific embodiment of the present application does not limit a specific implementation manner of the display control apparatus 500. As shown in FIG. 5, the display control apparatus 500 may comprise:

a processor 510, a communications interface 520, a memory 530, and a communications bus 540.

The processor 510, the communications interface 520, and the memory 530 communicate with each other via the communications bus 540.

The communications interface 520 is configured to communicate with, for example, a device having a communications function, an external light source or the like.

The processor 510 is configured to run a program 532, and specifically can perform the related steps in any one of the foregoing embodiments of the display control method.

For example, the program 532 may comprise program code, where the program code comprises a computer operating instruction.

The processor 510 may be a central processing unit (CPU), or an application specific integrated circuit (ASIC), or one or more integrated circuits configured to implement the embodiments of the present application.

The memory 530 is configured to store the program 532. The memory 530 may comprise a random access memory (RAM), and may also comprise a non-volatile memory (Non-volatile memory), for example, at least one magnetic disk memory. For example, in an optional embodiment, the processor 510 may run the program 532 to perform the following steps: adjusting a light distribution of a presentation area according to at least a light effect of a virtual content and information about a first presentation position of the virtual content in the presentation area; and controlling a display device to display the virtual content according to the information about the first presentation position. In other optional embodiments, the processor 510 may also run the program 532 to perform the steps mentioned above in any one of the other embodiments, and details are not described herein again.

For the steps in the program 532, reference may be made to the corresponding descriptions in the corresponding steps or modules in the foregoing embodiments, which are not described herein again. It may be clearly understood by a person skilled in the art that, for the purpose of convenient and brief description, reference may be made to the description of corresponding procedures in the foregoing method embodiments for detailed working procedures of the foregoing devices and modules, and details are not described herein again.

In the various embodiments of the present application, the serial numbers and/or sequence numbers of the embodiments are merely for the convenience of description, and do not imply the preference among the embodiments. Particular emphasis is put on the description about each embodiment, and reference can be made to relevant description of other embodiments for the content not detailed in an embodiment. Reference can be made to the description about the corresponding method embodiments for related description about the implementation principle or process of relevant apparatus, device or system embodiments, which is not repeated herein.

A person of ordinary skill in the art may be aware that, units and method steps of the examples that are described in conjunction with the embodiments disclosed in this specification may be implemented by electronic hardware or a combination of computer software and electronic hardware. Whether the functions are performed by hardware or software depends on particular applications and design constraint conditions of the technical solution. A person skilled in the art may use different methods to implement the described functions for each particular application, but it should not be considered that the implementation goes beyond the scope of the present application.

When the functions are implemented in a form of a software functional unit and sold or used as an independent product, the functions may be stored in a computer-readable storage medium. Based on such an understanding, the technical solutions of the present application essentially, or the part contributing to the prior art, or a part of the technical solutions may be implemented in a form of a software product. The computer software product is stored in a storage medium and comprises several instructions for instructing a computer device (which may be a personal computer, a controller, a network device, or the like) to perform all or some of the steps of the methods described in the embodiments of the present application. The foregoing storage medium comprises: any medium that can store program code, such as a USB flash drive, a removable hard disk, a read-only memory (ROM), a random access memory (RAM), a magnetic disk, or an optical disc.

In the embodiments of the apparatus, method, and system of the present application, apparently, the parts (a system, a subsystem, a module, a sub-module, a unit, a subunit, and the like) or steps may be decomposed or combined, and/or decomposed first and then combined. These decomposition and/or combination should be considered as equivalent solutions of the present application. In the above descriptions of the specific embodiments of the present application, a feature described and/or shown for one implementation may be used in one or more of other implementations in the same or similar manner and combined with a feature in another implementation, or replace a feature in another implementation.

It should be emphasized that, terms “comprise/include” used herein refer to existence of a feature, an element, a step, or a component, but do not exclude existence or addition of one or more of other features, elements, steps, or components.

Finally, it should be noted that the foregoing example embodiments are merely used to describe the present application, but are not intended to limit the present application. A person of ordinary skill in the art may further make various variations and modifications without departing from the spirit and scope of the present application. Therefore, all the equivalent technical solutions also fall within the scope of the present application, and the patent protection scope of the present application should be subject to the claims.

What is claimed is:

1. A method, comprising:
adjusting, by a system comprising a processor, a light distribution of a presentation area according to at least a light effect of virtual content and position information about a first presentation position of the virtual content in the presentation area; and
controlling, by the system, a display device to display the virtual content according to the position information about the first presentation position.

2. The method of claim 1, wherein the adjusting the light distribution of the presentation area comprises:
adjusting an illumination characteristic of at least one real light source in the presentation area according to at least the light effect and the position information about the first presentation position, so as to adjust the light distribution of the presentation area.

3. The method of claim 2, wherein the adjusting the illumination characteristic of the at least one real light source in the presentation area comprises:
acquiring distribution information about a source light distribution that generates the light effect on the virtual content; and
adjusting the illumination characteristic of the at least one real light source in the presentation area according to at least the distribution information about the source light distribution and the position information about the first presentation position.

4. The method of claim 2, wherein the illumination characteristic of the real light source comprises at least one of a light-emitting direction of a light emission, a luminance of the light emission or a color temperature of the light emission.

5. The method of claim 1, further comprising:
determining, by the system, the position information about the first presentation position of the virtual content in the presentation area.

6. The method of claim 1, further comprising: in response to a change in the first presentation position of the virtual content in the presentation area resulting in a changed first presentation position of the virtual content, adjusting, by the system, the light distribution of the presentation area according to at least the light effect and changed position information about the changed first presentation position of the virtual content.

7. The method of claim 1, wherein the position information is first position information, and wherein the adjusting the light distribution of the presentation area comprises:
determining, according to at least the light effect and the first position information about the first presentation position, virtual light augmentation information and second information about a second presentation position of the virtual light augmentation information in the presentation area; and
controlling the display device to display the virtual light augmentation information according to the second position information about the second presentation position.

8. The method of claim 7, wherein the determining, according to at least the light effect and the first position information about the first presentation position, the virtual light augmentation information and the second position information about the second presentation position of the virtual light augmentation information in the presentation area comprises:
determining, according to the light effect, the first position information about the first presentation position and the light distribution of the presentation area, the virtual light augmentation information and the second position information about the second presentation position of the virtual light augmentation information in the presentation area.

9. The method of claim 7, further comprising:
in response to a change in the first presentation position of the virtual content in the presentation area, updating, by the system, the virtual light augmentation information resulting in updated virtual light augmentation information and updating, by the system, the second position information about the second presentation position of the virtual light augmentation information in the presentation area resulting in updated second position information; and
controlling, by the system, the display device to display the updated virtual light augmentation information according to the updated second position information about the second presentation position.

10. The method of claim 7, wherein the virtual light augmentation information comprises: distribution information about a distribution of a virtual light luminance or a light color temperature.

11. The method of claim 1, wherein the light effect of the virtual content comprises: a distribution of a light luminance or a light color temperature on the virtual content.

12. The method of claim 1, wherein the display device comprises a near-to-eye display device.

13. An apparatus, comprising:
a memory that stores executable modules; and
a processor, coupled to the memory, that executes or facilitates execution of the executable modules, the executable modules comprising:
a light distribution adjusting module configured to adjust a light distribution of a presentation area according to at least a light effect of virtual content and first information about a first presentation position of the virtual content in the presentation area; and
a virtual content display control module configured to control a display device to display the virtual content according to the first information about the first presentation position.

14. The apparatus of claim 13, wherein the light distribution adjusting module comprises:
a real light source adjusting submodule configured to adjust an illumination characteristic of at least one real light source in the presentation area according to at least the light effect and the first information about the first presentation position, so as to adjust the light distribution of the presentation area.

15. The apparatus of claim 14, wherein the real light source adjusting submodule comprises:
a source light distribution information acquiring unit configured to acquire second information about a source light distribution that generates the light effect on the virtual content; and
an illumination characteristic adjusting unit configured to adjust an illumination characteristic of at least one real light source in the presentation area according to at least the second information about the source light distribution and the first information about the first presentation position.

16. The apparatus of claim 14, wherein the illumination characteristic of the at least one real light source comprises at least one a light-emitting direction of a light emission, a luminance of the light emission or a color temperature of the light emission.

17. The apparatus of claim 13, wherein the executable modules further comprise:
a first presentation position information determining module configured to determine the first information about the first presentation position of the virtual content in the presentation area.

18. The apparatus of claim 13, wherein the executable modules further comprise:
a light distribution updating module configured to: in response to a change in the first presentation position of the virtual content in the presentation area resulting in changed information about the first presentation position of the virtual content, adjust the light distribution of the presentation area according to at least the light effect and the changed information.

19. The apparatus of claim 13, wherein the light distribution adjusting module comprises:
a virtual augmentation information determining submodule configured to determine, according to at least the light effect and the first information about the first presentation position, virtual light augmentation information and second information about a presentation position of the virtual light augmentation information in the presentation area; and
a virtual augmentation information display control submodule configured to control the display device to display the virtual light augmentation information according to the second information about the second presentation position.

20. The apparatus of claim 19, wherein the virtual augmentation information determining submodule comprises:
a virtual augmentation information determining unit configured to determine the virtual light augmentation information and the second information about the second presentation position of the virtual light augmentation information in the presentation area according to the light effect, the first information about the first presentation position and the light distribution of the presentation area.

21. The apparatus of claim 19, wherein the executable modules further comprise:
a virtual augmentation information updating module configured to: in response to a change in the first presentation position of the virtual content in the presentation area, update the virtual light augmentation information resulting in updated virtual light augmentation information and update the second information about the second presentation position of the virtual light augmentation information in the presentation area resulting in updated second information; and
a virtual augmentation information display updating module configured to control the display device to display the updated virtual light augmentation information according to the updated second information about the second presentation position.

22. The apparatus of claim 19, wherein the virtual light augmentation information comprises: third information about at least one of a distribution of a virtual light luminance or a light color temperature.

23. The apparatus of claim 13, wherein the light effect of the virtual content comprises: at least one of a distribution of the light luminance or a light color temperature in the virtual content.

24. The apparatus of claim 13, wherein the display device comprises a near-to-eye display device.

25. A computer readable storage apparatus, comprising at least one executable instruction, which, in response to execution, causes a display control device to perform operations, comprising:
adjusting a light distribution of a presentation area according to at least a light effect of virtual content and information about a presentation position of the virtual content in the presentation area; and
controlling a display device to display the virtual content according to the information about the presentation position.

26. A display control apparatus, characterized by comprising a processor and a memory, the memory storing executable instructions, the processor being connected to the memory through a communication bus, and when the apparatus for controlling task migration operates, the processor executes the executable instructions stored in the memory, so that the display control apparatus executes operations, comprising:
adjusting a light distribution of a presentation area according to at least a light effect of a virtual content and information about a presentation position of the virtual content in the presentation area; and
sending display instructions to a display device to display the virtual content according to the information about the presentation position.
